(19) United States
(12) Patent Application Publication
(10) Pub. No.: US 2008/0110221 A1
(43) Pub. Date: May 15, 2008

(54) Dewatering Process

(76) Inventors: Simon Rose, West Yorkshire (GB); Lynn Lyons, West Yorkshire (GB); Mark Whtehead, West Yorkshire (GB)

Correspondence Address: JoAnn Villamizar;Ciba Corporation/Patent Department, 540 White Plains Road, P.O. Box 2005, Tarrytown, NY, 10591, US

(21) Appl. No.: 11/883,303

(22) PCT Filed: Jan. 31, 2006
(86) PCT No.: PCT/EP06/00795

§ 371 Date: Jul. 30, 2007

(30) Foreign Application Priority Data
Feb. 16, 2005 (GB) 0503152.1

(51) Int. Cl. C05D 1/00; C05D 3/00; C05D 9/00

(52) U.S. Cl. 71/28; 71/27

(57) ABSTRACT

A liquid foliar feed concentrate comprising, water containing therein, i) at least one foliar feed plant nutrient which is present in an amount of at least 5% weight of active nutrient based on total weight of the composition, ii) 800 to 50,000 ppm of at least one water-soluble polymer, and iii) 800 to 250,000 ppm of at least one surfactant. The foliar feed plant nutrient is preferably selected from the group consisting of NPK nutrients, calcium containing nutrients, urea, ammonium nitrate, potassium nitrate, mono ammonium phosphate, di ammonium phosphate, micronutrients and molybdenum containing nutrients. The preparation of the liquid foliar feed concentrates is also claimed. The invention also relates to the preparation of sprayable foliar feed compositions. The liquid concentrate can be used to prepare sprayable foliar feed compositions. The invention also describes a method of foliar feeding plant(s) using the sprayable compositions.

The present invention relates to foliar feed compositions including such compositions that are sprayable and contain at least one foliar feed plant nutrient and exhibit improved efficacy in nutrient uptake by plants. The invention in particular relates to liquid foliar feed concentrates that can be used to prepare the sprayable composition. The invention also provides a process of preparing the sprayable composition and a method of foliar feeding employing the sprayable composition.

It is well known in agriculture to apply various agrochemicals to growing areas by spraying. The growing areas may be crop areas, which can be very large, or smaller growing areas such as those in greenhouses. The agrochemicals applied as sprays include fertilisers, herbicides and pesticides.

Fertilisers can be supplied in various forms, in particular as solid compositions, or as suspensions or solutions of the fertiliser in a liquid. Fertiliser solutions are generally supplied by the manufacturer as an aqueous concentrate in large batches of size around 1 ton in weight. The solutions contain high concentrations, often 10 to 80 wt. % (dry solids), of dissolved inorganic fertiliser.

Herbicides and pesticides can be supplied to the farmer in various forms, for instance as neat liquids, aqueous solutions, aqueous dispersions or slurries of solid herbicide or pesticide. It is normal practice for the manufacturer to supply the farmer with the herbicide or pesticide in the form of a neat liquid or as a high activity solution or slurry. The usual way of applying herbicides or pesticides to an area of land would be by spraying.

U.S. Pat. No. 5,726,123 describes dilute compositions comprising plant growth stimulants containing chitosan which can be sprayed on to plants.

U.S. Pat. No. 5,432,147 refers to aqueous ready to use fungicidal compositions containing a polymeric thickener. The composition contains between 0.1 and 3% ammonium bicarbonate. The fungicidal composition is applied by electrodynamic spraying techniques.

U.S. Pat. No. 5,185,024 describes the use of polyacrylic hydrogels for agricultural applications which can be applied by spraying. The hydrogels act as water retention agents to prevent water loss from soil or on the leaf surface.

U.S. Pat. No. 5,125,952 refers to compositions containing melamine dispersions that can be used in fertiliser compositions for agriculture. The composition contains low levels of surfactant which would be associated with the dispersed melamine particles.

U.S. Pat. No. 4,525,197 teaches fertiliser compositions in the form of concentrated dispersions of undissolved nutrient materials.

Various systems have been devised for convenient dosing of fertilisers, herbicides or pesticides. Spray pumps are well known which spray water from a spray manifold onto the area of land or crop area and which are designed so that concentrated fertiliser solution, herbicide or pesticide can be dosed into the pump, mixed with water before being sprayed.

During the spraying of fertilisers, herbicides and pesticides it is common to apply anti-drift agents in order to prevent the formation of fine droplets which could be carried beyond the area intended to be treated. Without the use of anti-drift agents, the spraying of fertilisers, herbicides and pesticides would be inefficient, first of all because there could be inadequate treatment of the land and crop areas intended to be treated and secondly the extraneous spray, if carried beyond the intended treatment zone, could for example be detrimental to other crops, land and water courses.

It is usual to combine the anti-drift agent with either the water which is fed into the spray pumps or to apply it directly into the spray pumps, usually at or shortly after the mixing zone where the water is mixed with the herbicide, pesticide or aqueous fertiliser concentrate. It is important that the spray drift chemical is metered at the correct dose to ensure that extraneous spray is not formed through under dosing or through overdosing the spray angle is too narrow resulting in uneven distribution of the pesticide, herbicide or fertiliser.

Polymers of acrylamide and other ethylenically unsaturated monomers have been used as anti-drift agents. It has been generally accepted that polymers which give optimum spray drift control are either non-ionic (eg acrylamide homopolymer) or have relatively low anionic content (e.g. 5 to 30 wt. %) and also have relatively high intrinsic viscosity, for instance above 6 dl/g. Such polymers tend to form viscous aqueous solutions unless used at low concentration. Normal practice is to mix the polymer powder or reverse phase emulsion form with water directly into the spray tank so as to form an aqueous solution of polymer. However, this has the problem that emulsion polymers can be difficult to activate in this situation and polymer powders take a long time to dissolve. It is sometimes necessary to use more polymer as a result of inefficient dissolution of the polymer. Normally in order to minimise the problems with dissolution it would be usual to use polymers of intrinsic viscosity in the range 6 to 15 dl/g. Typically the water containing the pesticide, herbicide or fertiliser would comprise polymer at a concentration in excess of 0.05 wt. %.

For some applications it is usual to combine two or more agrochemicals. For instance in the application of herbicides, especially systemic herbicides, it is usual to combine the treatment with a fertiliser, such as for instance ammonium sulphate (AMS). The fertiliser stimulates the growth of unwanted plants causing them to take up much more water, together with the herbicide, through the root system. This ensures a more efficient uptake and distribution of herbicide throughout the plant. In this instance the fertiliser may be regarded as an adjuvant in that it increases the efficacy of the herbicide. Thus a fertiliser used in combination with a herbicide is termed a herbicide adjuvant

WO-A-00/26160 describes an agrochemical liquid concentrate containing herbicide or pesticide and an inorganic water-soluble compound adjuvant in an amount of at least 10% by weight. The concentrate includes an anti-drift agent which is a water-soluble anionic polymer in an amount up to 1.9 wt. % based on the weight of the concentrate. The concentrate would be diluted in a spray tank usually at least 30 fold, for instance at least 50 fold to form a sprayable composition. The systemic herbicide glyphosate is described as one example of an agrochemical. This composition provides significant improvements in reducing spray drift.

An article by Mickey R. Brigance entitled, “Effect of Polyacrylamide Formulations on Bioefficacy of Glyphosate” (Proceedings of the 7th International Symposium on Adjuvants for Agrochemicals, 8 to 12 Nov. 2004 (ISBN No. 1-92 0-01716-X)) describes the evaluation of sprayable herbicidal compositions of glyphosate and the enhancement by polyacrylamides in simple and multifunctional tank mix formulations. The study found that the higher surfactant loaded glyphosate formulations showed smaller increases in efficacy from the polyacrylamide inclusion and that the glyphosate formulations with very low or no surfactants showed the greatest efficacy increase. This study considers drift suppression by reducing fine droplets and reducing droplet bounce for herbicidal formulations.

U.S. Pat. No. 6,423,109 also published as US 2002/000006874 describes a free-flowing fertilizer comprising 25 to 99.5% by weight powdered water-soluble nitrogen containing fertilizer, 0.05 to 1.5% by weight of a polyacrylamide liquid emulsion or dispersion and from 0.1 to 3.0% by weight of a polyacrylamide powder was possible size is 50 to 100 mesh in size. The fertilizer may also comprise up to 5% of a powdered silicone defoamer, up to 30% of a non-ionic powdered surfactant, up to 50% sequestering agents or metal complexes thereof and up to 1.5% anti caking compounds. This disclosure sets out to provide a convenient easy to use fertilizer composition which provides improved resistance to off target drift as well as improved deposition on to the desired target.

The prior art deals with spray drift control and prevention of droplet bounce. However, a problem which exists concerns droplet runoff. With known treatments the sprayed droplets may land on a leaf and may not bounce from the leaf but the droplets can nonetheless still run off the leaf. The present invention sets out to provide foliar feed plant nutrient formulations which overcome this problem.

Furthermore, it would be desirable to reduce or eliminate droplet runoff whilst maintaining or improving droplet bounce and spray drift control.

Thus according to the present invention we provide a liquid foliar feed concentrate comprising,

water containing therein,
i) at least one foliar feed plant nutrient which is present in an amount of at least 10% weight of active nutrient based on total weight of the composition,
ii) 800 to 50,000 ppm of at least one water-soluble polymer, and
iii) 2,500 to 250,000 ppm of at least one surfactant.

This liquid concentrate can be diluted to form a sprayable formulation.

We have found that this combination of water-soluble polymer and surfactant in the final sprayable formulation formed from the liquid concentrate of the present invention reduces droplet runoff. Without being limited theory we believe that there may be an interaction between the polymer and the surfactant that results in improved attraction between the plant foliage and the sprayed droplets. The mechanism involved in reduced droplet runoff is thought to be quite different from the mechanism that occurs in reducing droplet bounce.

Preferably, the foliar feed plant nutrient is selected from the group consisting of NPK nutrients, calcium containing nutrients, urea, ammonium nitrate, potassium nitrate, mono ammonium phosphate, di ammonium phosphate, micronutrients and molybdenum containing nutrients.

The amount of foliar feed plant nutrient in this liquid concentrate should be at least 10% weight of active nutrient based on total weight of the composition. In general the amount of active nutrient present in the liquid concentrate should be sufficient upon dilution from 20 to 100 fold to give the desired concentration in the above described sprayable composition. Preferably, the amounts of nutrient will be much higher, for instance at least 30 or 40% or more. In general the amount of nutrient will be up to 40% by weight.

So far as the diluted spray formulation is concerned, in general the foliar feed plant nutrient may be present in an amount of at least 0.01% weight of active nutrient based on total weight of composition. For micronutrients, such as trace elements, the amount of nutrient present may be relatively low, for instance 0.01% up to 0.1%. Other nutrients such as calcium based nutrients may be present at much higher concentrations, for instance 0.1% to 5% or more, preferably one to 5%. NPK nutrients tend to be present at concentrations of at least 0.5% by weight, typically 0.7 to 3% or more.

It may be desirable to include other components in the liquid concentrate or sprayable composition provided that they do not have a deleterious effect on the objective of providing nutrient to the plant. However, normally inclusion of additional components will not be necessary. The present invention concerns plant nutrition as opposed to eradication of undesirable plants or pests. Consequently, the inclusion of a substance, such as a herbicide, that would lead to the destruction of the plant would be counterproductive to the objective of the invention.

Preferably the liquid concentrate will comprise 2,000 and 25,000 ppm by weight, more preferably between 3000 and 10,000 ppm, of water-soluble polymer based on the total weight of the composition.

The liquid concentrate preferably contains surfactant in an amount between 2,500 and 150,000 ppm by weight, more preferably 5000 to 50,000 ppm, based on the total weight of the composition.

Preferably the amount of water-soluble polymer in the diluted sprayable formulation should be between 40 and 600 ppm by weight, more preferably 100 to 500 ppm, based on total weight of the composition. Preferably the amount of surfactant should be between 50 and 3000 ppm by weight, more preferably 500 to 2000 ppm, based on the total weight of the composition. Generally we find optimum results are achieved when the polymer and/or surfactant is/are present in this range.

The invention provides an aqueous composition in which the water-soluble polymer is preferably substantially dissolved. That is, the polymer is taken into the solution such that substantially no visible solid material remains. The polymer may be prepared by polymerisation of a water soluble monomer or water soluble monomer blend. By water soluble we mean that the water soluble monomer or water soluble monomer blend has a solubility in water of at least 5 g in 100 ml of water. The polymer may be prepared conveniently by any suitable polymerisation process.

Desirably the polymer may be prepared by reverse phase emulsion polymerisation, optionally followed by dehydration under reduced pressure and temperature and often referred to as azeotropic dehydration to form a dispersion of polymer particles in oil. Alternatively the polymer may be provided in the form of beads by reverse phase suspension polymerisation, or as a powder by aqueous solution polymerisation followed by comminution, drying and then grinding. The polymers may be produced as beads by suspension polymerisation or as a water-in-oil emulsion or dispersion by water-in-oil emulsion polymerisation, for example according to a process defined by EP-A-150933, EP-A-102760 or EP-A-126528.

The polymer may be branched but in general it is substantially linear and is not cross-linked.

The polymer desirably may have intrinsic viscosity at least 6 dl/g. In this specification intrinsic viscosity is measured by suspended level viscometer at 20° C. in 1 M sodium chloride buffered to pH 7. That is of sufficiently high molecular weight to give spray drift control properties and is not a low molecular weight material which would act as a dispersant.

Intrinsic viscosity of polymers may be determined by preparing an aqueous solution of the polymer (0.5-1% w/w) based on the active content of the polymer. 2 g of this 0.5-1% polymer solution is diluted to 100 ml in a volumetric flask with 50 ml of 2M sodium chloride solution that is buffered to pH 7.0 (using 1.56 g sodium dihydrogen phosphate and 32.26 g disodium hydrogen phosphate per litre of deionised water) and the whole is diluted to the 100 ml mark with deionised water. The intrinsic viscosity of the polymers are measured using a Number 1 suspended level viscometer at 25° C. in 1M buffered salt solution.

Preferably IV is at least 8 dl/g, more preferably at least 9 dl/g. It may be up to for instance 30 dl/g but generally it is found that the optimum combination of low viscosity of the composition and spray drift control performance is given by polymers having IV not more than about 20 or 18 dl/g. Preferably IV is not more than 16, more preferably not more than 15 dl/g. Particularly preferred IV ranges are from 9 to 13 dl/g, especially 10 to 12 dl/g.

The polymer is formed from water soluble monomer or monomer blend, usually water soluble ethylenically unsaturated monomer. The anionic content i.e. the proportion of anionic monomer in the monomer blend used to form the polymer, is variable from 0% up to 100 wt. %, but is preferably not more than 80 wt. %, more preferably not more than 70 wt. %, most preferably not more than 60 wt. %. Particularly preferred polymers have anionic content in the range 0 to 50 wt. %, more preferably in the range 0 to 30 wt. %.

The monomer or monomer blend used to form the polymer comprises any suitable anionic ethylenically unsaturated monomer. It can be a sulphonic monomer, often as sodium or other alkali metal salt, for instance 2-acrylamido-2-methylpropane sulphonic acid. It is generally preferred that the anionic monomer is an ethylenically unsaturated carboxylic monomer, in particular acrylic or methacrylic monomer. Salts of acrylic acid are preferred, for instance ammonium or alkali metal, in particular sodium salts.

The polymer may contain small amounts of cationic monomer, for instance up to 20 wt. % or 10 wt. % but usually the content of cationic monomer is substantially zero.

Generally the anionic monomer is copolymerised with nonionic monomer, usually ethylenically unsaturated water soluble non-ionic monomer such as acrylamide or methacrylamide, preferably acrylamide. Particularly preferred polymers are copolymers of acrylamide with sodium acrylate.

The polymer is included in the composition in an amount such that when the surfactant is present it provides adequate spray drift control performance and reduced droplet bounce and reduced droplet runoff.

The exact choice of surfactant will depend upon the particular nutrients used, types of plant, choice of polymer and the location. Effective results are obtained when the surfactant is selected from the group consisting of tallow amine ethoxylates, alkyl phenol ethoxylates, alcohol ethoxylates and alkyl poly glucosides.

The liquid concentrate can be provided by mixing into a solution of the nutrient already at the desired concentration the desired amount of water-soluble polymer and the desired amount of surfactant. The polymer and the surfactant may be added in either order or simultaneously although preferably the polymer is added first. The polymer may be added as a dry powder to the nutrient solution, but preferably it is added as an aqueous solution. The aqueous solution may be prepared by dissolving dry powdered polymer in water or alternatively by inverting a reverse phase emulsion or dispersion of the polymer.

In another aspect of the present invention a sprayable foliar feed composition comprising the steps of providing the liquid foliar feed concentrate of the invention and then diluting said concentrate at least tenfold with water.

In a further aspect of the invention we provide a process of preparing the sprayable foliar feed composition as defined previously comprising the steps of providing the liquid foliar feed concentrate as already described and then diluting said concentrate at least ten fold with water. The concentrate may be diluted as much as one hundred fold but generally will be diluted between 20 and 50 fold.

An alternative process of preparing the sprayable foliar feed composition according to the invention comprises the steps of,

providing a liquid foliar feed concentrate comprising,
water containing therein,
i) at least one foliar feed plant nutrient which is present in an amount of at least 5% weight of active nutrient based on total weight of the composition,
ii) 800 to 50,000 ppm of at least one water-soluble polymer, and
   then diluting said concentrate at least tenfold with water to form a liquid dilution, and then mixing iii) 40 to 5000 ppm of at least one surfactant, based on the weight of the final sprayable composition, into the liquid dilution to form the sprayable foliar feed composition.

According to the present invention we also provide a use of a liquid foliar feed concentrate, which forms a sprayable composition for foliar feeding one or plants, for purpose of reducing droplet run-off,

which concentrate comprises, water containing therein,
i) at least one foliar feed plant nutrient,
ii) 800 to 50,000 ppm of at least one water-soluble polymer, and
iii) 800 to 250,000 ppm of at least one surfactant.

Typically amount of foliar feed plant nutrient in this liquid concentrate is at least 0.5% weight of active nutrient based on total weight of the composition. In general the amount of active nutrient present in the liquid concentrate should be sufficient upon dilution from 20 to 100 fold to give the desired concentration in the above described sprayable composition. Preferably, the amounts of nutrient will be much higher, for instance at least 1 or 2% by weight and sometimes as high as 10% or even 30 or 40% or more. Preferably the composition will contain at least 2,500 ppm of at least one surfactant. More preferably though, the composition will contain amount of polymer and surfactant as indicated above.

In a still further aspect of the invention we provide a method of foliar feeding one or more plants comprising the steps of applying to the foliage of said one or more plants a sprayable foliar feed composition described above. Preferably the sprayable foliar feed composition will be obtaining by diluting the liquid concentrate of the invention. In general the sprayable foliar feed composition comprises,

water containing therein,
i) at least one foliar feed plant nutrient,
ii) 40 to 1000 ppm of at least one water-soluble polymer, and
iii) 40 to 5000 ppm of at least one surfactant,

The sprayable composition may include any of the aforementioned defined features.

The invention is applicable to both agriculture and horticulture. However, in general the invention is suitably applied to a crop area. Typically the foliar feed composition is sprayed onto a crop area at a treatment rate of at least 0.5 kilograms per hectare.

The following examples demonstrate the invention without in anyway intending to be limiting.

### EXAMPLE 1

### Effect on Spray Drift

Improved deposition of the enhanced foliar feeds can be demonstrated by measuring the mass of the composition that is deposited when the solution is sprayed under standard conditions.

Test solutions were sprayed into a wind tunnel (dimensions length 3 m, height 2 m, width 2.5 m). A spray head containing a 110° flat fan nozzle was mounted 60 cm above the floor. Wind at 6 mph (measured at the centre of the tunnel) was generated using a fan placed at a distance of 10 cm behind nozzle. A 1.5M² and 5 cm tall collection area was positioned centrally under the spray head such that a 1.4 m length of the tray was down wind from the nozzle. The solution to be tested was placed in a brass spray canister attached to the spray head. The canister, tubing and spray head were then weighed. A source of compressed air was used to expel the test solution through the nozzle at a pressure of 3 bar onto a pre-weighed plastic sheet, which was used to cover the collection area. The test solution was sprayed for 135 seconds. The canister and spray head were then reweighed in order to determine the weight of the solution expelled. The plastic sheet was carefully folded and reweighed. The mass of the solution collected was then calculated and used to determine the loss of spray due to drift.

Test solutions were prepared to give rates for the foliar feeds similar to those used in the field as follows;

| | Field/test rate |
|---|---|
| Calcium chloride solution (12.3% Ca) | 0.32% w/v |
| Urea prills (46% N) | 0.48% w/v |
| Calcium Nitrate prills (19% Ca) | 0.60% w/v |
| Librel Mn | 0.12% w/v |

The polymers were added to the test solution at a rate of 400 ppm.

TABLE 1

| | | Mass spray lost |
|---|---|---|
| Foliar feed | Polymer | (%) |
| Calcium Chloride | None | 8.8 |
| Urea | None | 8.1 |
| Librel Mn | None | 7.9 |
| Librel Mn | Polymer A | 3.3 |
| Calcium Chloride | Polymer A | 2.5 |
| Urea | Polymer B | 1.8 |
| Calcium Chloride | Polymer B | 1.5 |

### Where:

### Polymer A is a solid grade polyacrylamide with an anionic content of 29% and an intrinsic viscosity of 12 dl/g

### Polymer B is a solid grade polyacrylamide with an anionic content of 0% and an intrinsic viscosity of 16 dl/g

The results showed that the small droplets remain airborne and are lost. The incorporation of a polymer increased the mass of spray deposited by around 6%.

### EXAMPLE 2

### Effect on Droplet Bounce

The average distance that droplets bounce with and without polymer/surfactant can be determining using the following method.

A Hewlett Packard 214B Pulse generator connected to a piezo-electric disc connected to a flat tipped glass nozzle with an aperture of 5000 μm was used to generate droplets of ˜1000 μm in diameter. The glass nozzle tip was mounted 20 cm above the leaf surface, which was set at an angle of 45°.

Each droplet was allowed to fall 20 cm before impacting with a Pea leaf (variety used in this study was Lincoln pea leaves) and the result is recorded. Libsorb, a commercial nonyl phenol ethoxylate (NPE)) was used in combination with the polymer in some of the test solutions. It's also useful to report these results as the percentage of droplets that would be deflected from an average sized leaf. As can be seen both our test polymers reduced the bounce to a similar level as the surfactant and the combination of surfactant and Polymer B virtually eliminated droplet bounce. The rates of the calcium chloride and polymers were identical to those used in example 1.

TABLE 2

| | | % Droplets |
|---|---|---|
| Solution | Bounce (cm) | deflected |
| CaCl2 alone | 11.15 | 100% |
| CaCl2 + NPE | 4.58 | 84% |
| CaCl2 + Polymer A | 4.74 | 70% |
| CaCl2 + Polymer B | 3.48 | 66% |
| CaCl2 + NPE + Polymer A | 2.01 | 32% |
| CaCl2 + NPE + Polymer B | 0.33 | 6% |

We believe the mechanisms involved for the surfactant and polymer are different and complementary.

### EXAMPLE 3

### Effect of Droplet Runoff

When droplets are successfully deposited they can roll off a leaf if the leaf moves in the wind etc. The following test can be used to determine the critical angle at which droplet detachment occurs which would result in the droplet rolling of a leaf surface.

A droplet of ˜5000 microns in diameter (generated using the equipment described in example 2) of the solution to be tested was deposited on a glass plate covered with a 5 cm² piece of Parafilm. One end of the glass plate was held in place, the opposite end was attached to a movable platform. The solution was deposited on the plate held horizontally at 0°. The platform was then slowly and smoothly raised upwards until the droplet began to move. The angle of the glass plate was then measured and recorded. A range of polymers was tested in combination with surfactants (either tallow amine ethoxylate (TAE) or nonyl phenol ethoxylate (NPE)). All the tests were performed using calcium chloride as the foliar feed solution.

The results of this test are reported in Table 3.

TABLE 3

| | | | | | % |
|---|---|---|---|---|---|
| | Surfactant | | Polymer | Critical | Improvement |
| Surfactant | Dose | Polymer | Dose | Angle | over control |
| none | none | none | none | 26 | NA |
| none | none | Polymer A | 200 ppm | 18 | −32% |
| none | none | Polymer A | 400 ppm | 25 | −5% |
| none | none | Polymer B | 400 ppm | 60 | 132% |
| none | none | Polymer C | 100 ppm | 24 | −10% |
| none | none | Polymer C | 200 ppm | 31 | 19% |
| none | none | Polymer C | 400 ppm | 39 | 50% |
| NPE | 300 ppm | none | none | 30 | 13% |
| NPE | 300 ppm | Polymer A | 100 ppm | 35 | 33% |
| NPE | 300 ppm | Polymer A | 200 ppm | 32 | 24% |
| NPE | 300 ppm | Polymer A | 400 ppm | 33 | 26% |
| NPE | 300 ppm | Polymer B | 400 ppm | 40 | 53% |
| NPE | 300 ppm | Polymer C | 400 ppm | 37 | 43% |
| TAE | 1000 ppm | none | none | 23 | −11% |
| TAE | 1000 ppm | Polymer A | 100 ppm | 27 | 3% |
| TAE | 1000 ppm | Polymer A | 200 ppm | 36 | 37% |
| TAE | 1000 ppm | Polymer A | 400 ppm | 35 | 34% |
| TAE | 1000 ppm | Polymer B | 100 ppm | 30 | 16% |
| TAE | 1000 ppm | Polymer B | 200 ppm | 29 | 11% |
| TAE | 1000 ppm | Polymer B | 400 ppm | 43 | 63% |
| TAE | 1000 ppm | Polymer C | 400 ppm | 38 | −11% |

### Where:

### Polymer C is a liquid dispersion grade polymer containing 50% w/w of a polyacrylamide with an anionic content of 40% and an intrinsic viscosity of 12 dl/g

The results show that in general polymers increase the critical angle at which droplets are expelled, i.e. droplets containing polymer are less likely to run off sprayed crops. Selection of polymer/surfactant combination is critical as the effect of the polymer is dependant on the surfactant present in the system and the nature of the polymer. Polymer B gave the best results with the calcium chloride based foliar feed.

### EXAMPLE 4

### Effect of Droplet Runoff

The test used in example three was repeated using a number of foliar feeds tested previously. All the solutions under test contained a surfactant (tallow amine ethoxylate@1000 ppm). The rates for the foliar feeds tested previously were identical to those used in example one. Libspray 211 (a propriety NPK based feed containing a range of chelated micronutrients) was sprayed at a rate of 1% v/v.

TABLE 4

| | | | Critical angle | | |
|---|---|---|---|---|---|
| | | Polymer | without | Critical angle | % |
| Nutrient | Polymer | dose (ppm) | polymer | with polymer | Improvement |
| Librel Mn | Polymer A | 200 | 28.8 | 49.3 | 70.8% |
| Urea | Polymer B | 400 | 32.3 | 44.4 | 37.7% |
| Libspray 211 | Polymer D | 400 | 28.9 | 36.8 | 27.2% |
| Libspray 211 | Polymer B | 400 | 29.1 | 36.3 | 24.8% |
| Libspray 211 | Polymer A | 200 | 30.2 | 36.1 | 19.4% |
| Urea | Polymer D | 400 | 32.7 | 38.2 | 16.6% |
| Urea | Polymer A | 400 | 32.8 | 37.9 | 15.5% |

### Where:

### Polymer D is a solid grade polyacrylamide with an anionic content of 65% and an intrinsic viscosity of 10 dl/g

The results show that the choice of the optimum polymer for controlling droplet run off is dependant on the chemistry of the foliar feed.

1. A liquid foliar feed concentrate comprising,
water containing therein,
i) at least one foliar feed plant nutrient which is present in an amount of at least 10% weight of active nutrient based on total weight of the composition,
ii) 800 to 50,000 ppm of at least one water-soluble polymer, and
iii) 2,500 to 250,000 ppm of at least one surfactant.

2. A liquid concentrate according to claim 1 in which the foliar feed plant nutrient is selected from the group consisting of NPK nutrients, calcium containing nutrients, urea, ammonium nitrate, potassium nitrate, mono ammonium phosphate, di ammonium phosphate, micronutrients and molybdenum containing nutrients.

3. A liquid concentrate according to claim 1 in which the amount of water-soluble polymer is between 2,000 and 25,000 ppm by weight based on the total weight of the composition.

4. A liquid concentrate according to claim 1 in which the amount of surfactant is between 2,500 and 150,000 ppm by weight based on the total weight of the composition.

5. A liquid concentrate according to claim 1 in which the water-soluble polymer exhibits and intrinsic viscosity of at least 6 dl/g.

6. A liquid concentrate according to claim 1 in which the surfactant is selected from the group consisting of tallow amine ethoxylates, alkyl phenol ethoxylates, alcohol ethoxylates and alkyl poly glucosides.

7. A process of preparing a liquid concentrate defined according to claim 1 comprising the steps of mixing into a solution of the nutrient already at the desired concentration the desired amount of water-soluble polymer and the desired amount of surfactant, wherein the concentration of nutrient, amount of water-soluble polymer and the amount of surfactant is sufficient to provide
i) at least 10% weight of active nutrient based on total weight of the composition,
ii) 800 to 50,000 ppm of at least one water-soluble polymer, and
iii) 2,500 to 250,000 ppm of at least one surfactant.

8. A process of preparing a sprayable foliar feed composition comprising the steps of providing a liquid foliar feed concentrate as defined by claim 1 and then diluting said concentrate at least tenfold with water.

9. A process of preparing a sprayable foliar feed composition by providing a liquid foliar feed concentrate comprising,
water containing therein,
i) at least one foliar feed plant nutrient which is present in an amount of at least 10% weight of active nutrient based on total weight of the composition,
ii) 800 to 50,000 ppm of at least one water-soluble polymer, and
then diluting said concentrate at least tenfold with water to form a liquid dilution, and then mixing iii) 40 to 5,000 ppm of at least one surfactant, based on the weight of the final sprayable composition, thereby forming the sprayable foliar feed composition.

10. A process of foliar feeding one or more plants comprising the steps of applying to the foliage of said one or more plants a sprayable foliar feed composition, wherein the sprayable foliar feed composition is as defined in claim 8.

11. A process according to claim 10 in which the sprayable foliar feed composition is sprayed onto a crop area at a treatment rate of at least 0.5 kg per hectare.

12. (canceled)

13. A process of foliar feeding one or more plants comprising the steps of applying to the foliage of said one or more plants a sprayable foliar feed composition, wherein the sprayable foliar feed composition is as defined in claim 9.
